(19) United States
(12) Patent Application Publication
(10) Pub. No.: US 2026/0241275 A1
(43) Pub. Date: Aug. 20, 2026

(54) INFORMATION PROCESSING DEVICE, INFORMATION PROCESSING METHOD, PROGRAM, AND CONTENT DELIVERY SYSTEM

(71) Applicant: SONY GROUP CORPORATION, TOKYO (JP)

(72) Inventors: HIROAKI MOTOHASHI, TOKYO (JP); AYUMI KOBAYASHI, TOKYO (JP)

(21) Appl. No.: 19/161,823

(22) PCT Filed: Mar. 6, 2024
(86) PCT No.: PCT/JP2024/008580

§ 371 Date: Sep. 3, 2025

(30) Foreign Application Priority Data
Mar. 13, 2023 (JP) 2023-038308

(51) Int. Cl. A63F 13/355; A63F 13/52

(52) U.S. Cl. CPC A63F 13/355; A63F 13/52

(57) ABSTRACT

Disclosed is an information processing device including a monitoring section and a launching section. The monitoring section detects a predefined trigger on the basis of a snapshot from a first virtual space that acts as a dedicated server. In a case where the monitoring section detects the trigger, the launching section launches an instance for operating a second virtual space that acts as a dedicated server different from the first virtual space and that renders and generates content.

### TECHNICAL FIELD

The present technology relates to an information processing device, an information processing method, a program, and a content delivery system.

### BACKGROUND ART

In recent years, various types of online content have been provided to allow many players to participate. Such content includes, for example, a multi-online game (sometimes called a cloud game) in which one game is played simultaneously by two or more players, a virtual live performance held in a virtual space drawn, for example, by CG (Computer Graphics), and a metaverse in which many players become avatars and perform various activities in a virtual space.

In order for players to participate in such content, a drawing process called rendering is required, and rendering requires as many GPUs (Graphics Processing Units) as there are players' perspectives. High-performance GPUs are needed to improve the video quality of content. However, the use of high-performance GPUs is very costly and therefore not realistic for content used by many players.

Consequently, for use in a drawing system for a multi-online game, there has been proposed a technology that allows multiple GPU servers to use a repository of static objects (resources) to thereby efficiently exchange data and reduce the load on a data center (PTL 1).

### CITATION LIST

### Patent Literature

### PTL 1

JP-T-2017-510862

### SUMMARY

### Technical Problem

The technology described in PTL 1 is able to perform a drawing process while reducing the load, for example, in certain multi-online games. However, the GPU servers are provided uniformly even in a case where content requiring different types of GPU processing (light content or movie-quality content) is to be rendered. Therefore, the technology described in PTL 1 is not always able to provide high-quality content according to needs such as those dependent on the type of content and requests from players.

The present technology has been made in view of the above circumstances. An object of the present technology is to provide an information processing device, an information processing method, a program, and a content delivery system that are able to generate high-quality content according to needs such as those dependent on the type of content and requests from players.

### Solution to Problem

In order to solve the above problem, according to a first technology, there is provided an information processing device including a monitoring section and a launching section. The monitoring section detects a predefined trigger on the basis of a snapshot from a first virtual space that acts as a dedicated server. In a case where the monitoring section detects the trigger, the launching section launches an instance for operating a second virtual space that acts as a dedicated server different from the first virtual space and that renders and generates content.

Further, according to a second technology, there is provided an information processing method including detecting a predefined trigger on the basis of a snapshot from a first virtual space acting as a dedicated server, and launching, in a case where the trigger is detected, an instance for operating a second virtual space that acts as a dedicated server different from the first virtual space and that renders and generates content.

In addition, according to a third technology, there is provided a program for causing a computer to execute an information processing method including detecting a predefined trigger on the basis of a snapshot from a first virtual space acting as a dedicated server, and launching, in a case where the trigger is detected, an instance for operating a second virtual space that acts as a dedicated server different from the first virtual space and that renders and generates content.

Moreover, according to a fourth technology, there is provided a content delivery system including a first virtual space, a second virtual space, and an information processing device. The first virtual space acts as a dedicated server. The second virtual space acts as a dedicated server different from the first virtual space and renders and generates content. The information processing device includes a monitoring section and a launching section. The monitoring section detects a trigger on the basis of a snapshot transmitted from the first virtual space. In a case where the monitoring section detects the trigger, the launching section launches an instance for operating the second virtual space.

### BRIEF DESCRIPTION OF THE DRAWINGS

FIG. 1 is a diagram illustrating a typical physical configuration of a multi-online game.

FIG. 2 is a block diagram illustrating a configuration of a content delivery system 10.

FIG. 3 is a block diagram illustrating a configuration of an information processing device 300.

FIG. 4 is a diagram illustrating a first virtual space table.

FIG. 5 is a diagram illustrating a content table.

FIG. 6 is a diagram illustrating a trigger table.

FIG. 7 is a diagram illustrating a second virtual space table.

FIG. 8 is a diagram illustrating a sensor table.

FIG. 9 is a diagram illustrating a delivery destination table.

FIG. 10 is a diagram illustrating a rendering table.

FIG. 11 is a diagram illustrating a perspective table.

FIG. 12 is a diagram illustrating a perspective selection parameter table.

FIG. 13 is a flowchart illustrating a process performed in the information processing device 300.

FIG. 14 is a sequence diagram illustrating a process related to trigger detection.

FIG. 15 is a sequence diagram illustrating a process related to scale-out.

FIG. 16 is a sequence diagram illustrating a process related to the construction of a second virtual space 200.

FIG. 17A depicts a map of a game space constructed in a first virtual space 100, and FIG. 17B is a diagram illustrating a fixed perspective that is set on the map of the game space.

FIG. 18A depicts a first-person perspective game screen, and FIG. 18B depicts a third-person perspective game screen that is rendered in the second virtual space 200.

FIG. 19 is a sequence diagram illustrating a process related to perspective switching.

FIG. 20A is a diagram illustrating a virtual live space according to a modification of the present technology, and FIG. 20B is a diagram illustrating a fixed perspective that is set in the virtual live space.

### DESCRIPTION OF THE EMBODIMENT

An embodiment of the present technology will now be described with reference to the accompanying drawings. It should be noted that the description will be given in the following order.

### 1. Embodiment

1-1. Configuration of Content Delivery System 10
1-2. Configuration of Information Processing Device 300
1-3. Processes in Content Delivery System 10 and Information Processing Device 300

### 2. Modifications

### 1-1. Configuration of Content Delivery System 10

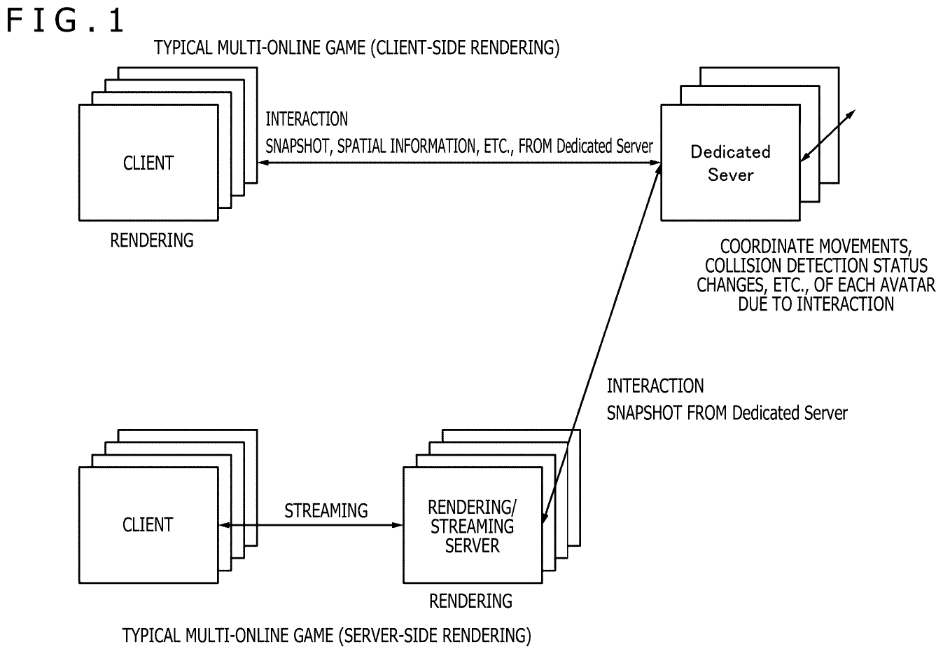

An embodiment of the present technology is described below with reference to a case where, for example, a person who plays a game (hereinafter referred to as a player) uses a client to play a multi-online game. First, a typical system configuration of the multi-online game will be described with reference to FIG. 1. The multi-online game (hereinafter sometimes simply referred to as a game) is an online game in which multiple players (e.g., several to several thousand players) are allowed to participate simultaneously through a network. The multi-online game allows a player to operate his/her own avatar to fight or compete with other players, or cooperate or interfere with each other and communicate with each other while playing. The avatar is, for example, an image or 3D model that represents a character associated with a player of the multi-online game. The client is a video game console, a handheld game console, a personal computer, a smartphone, or any other electronic device that is used by a player who plays the multi-online game.

FIG. 1 illustrates a typical system configuration of the multi-online game in the case of client-side rendering and in the case of server-side rendering. A multi-online game system includes a client, a dedicated server, and a rendering/streaming server. Due to the multi-online game, each client shares the same game space.

The dedicated server is involved in one form of client-server model operation, for example, in an online game, in which there is a dedicated machine that is configured to play only the role of a server and is to be accessed by all clients. The rendering/streaming server is a server that renders a game screen of the multi-online game and streams such a game screen.

In client-side rendering, the client side performs rendering to generate a game screen including a game space and avatars. First, commands and settings (interactions) inputted by the player through the client are transmitted to the dedicated server. Next, the dedicated server updates the game space on the basis of the commands and settings inputted from the player through each client sharing the game space, and transmits, for example, a snapshot, spatial information, and a drawing command to each client. The snapshot includes, for example, information such as the coordinates and status of avatars and objects in the game space and information inputted by the player through the client (instructions and information inputted through a game console controller or smartphone). The spatial information includes, for example, map data and terrain data regarding the game space. Subsequently, the client performs rendering to generate the game screen on the basis of the received information. The above-described process is repeated sequentially until the game ends.

Meanwhile, in server-side rendering, the client connects to the dedicated server through the rendering/streaming server. First, the commands and settings (interactions) inputted by the player through the client are transmitted to the dedicated server through the rendering/streaming server. Next, the dedicated server updates the game space on the basis of the commands and settings inputted from the player through each client sharing the game space, and transmits the snapshot and the spatial information to each rendering/streaming server. Subsequently, the rendering/streaming server renders the game space and received information regarding avatar status to generate the game screen, and streams game screen data to the client. The above-described process is repeated sequentially until the game ends.

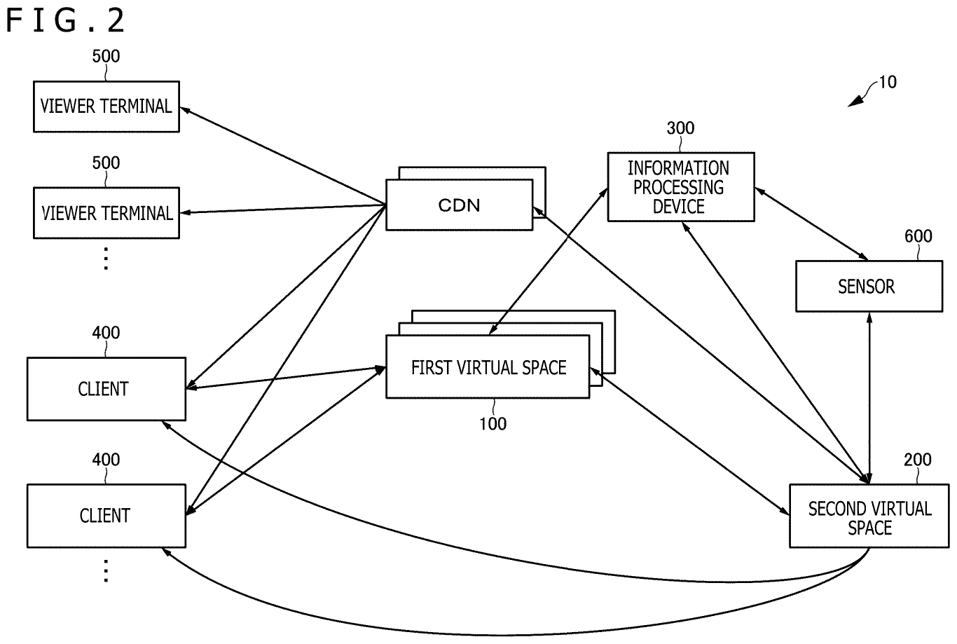

A configuration of a content delivery system 10 will now be described with reference to FIG. 2. The content delivery system 10 includes a first virtual space 100, a second virtual space 200, an information processing device 300, a client 400, a viewer terminal 500, and a sensor 600.

The first virtual space 100 is a dedicated game server (dedicated server) in the multi-online game involving interactions with multiple clients 400. The first virtual space 100 communicates with the clients 400 configured to perform client-side rendering and with a server configured to perform server-side rendering, and transmits and receives, for example, snapshots, spatial information, and commands on the dedicated game server.

The first virtual space 100 has the function of the dedicated game server, which constructs a game space from information regarding avatars and objects in the game and from the map data, reflects input that is made by the player through the client 400, and transmits, for example, the status of the game space and the drawing command to the client 400 used by the player. Further, in response to a request from the information processing device 300, the first virtual space 100 transmits the snapshot and the spatial information to the second virtual space 200. In the present embodiment, the first virtual space 100 is a dedicated server for a typical multi-online game. Therefore, the first virtual space 100 has interactivity and does not have a rendering function. However, the present technology is not limited to such a configuration. The first virtual space 100 may have the rendering function. Further, unlike the second virtual space 200, the first virtual space 100 has no limit on the number of perspectives of the game screen.

The server for operating the dedicated game server which is the first virtual space 100 may be an on-premises server or a server such as a public cloud server. The first virtual space 100 is connected to the second virtual space 200, the information processing device 300, and the client 400. As a connection method, an RPC (Remote Procedure Call) or a gRPC (Google Remote Procedure Call) can be used, for example, over HTTP (Hyper Text Transfer Protocol), HTTP2, or HTTP3.

The second virtual space 200 is a dedicated game server that constructs the game space status on the basis of the snapshot and spatial information transmitted from the first virtual space 100. Further, the second virtual space 200 has the function of rendering and generating the game screen as a rendering server and the function of delivering the generated game screen as a streaming server. The game screen is an example of video content that is rendered by the second virtual space 200.

The second virtual space 200 performs rendering from a predefined fixed perspective on the basis of the snapshot and spatial information transmitted from the first virtual space 100, and delivers the rendered game screen, for example, to the client 400 and viewer terminal 500 of the player who has been interacting in the first virtual space 100.

The second virtual space 200 has a limited number of perspectives as rendering perspectives, and therefore allows for higher-spec GPU processing than the first virtual space 100. This makes it possible to allocate many resources to game screen rendering, and thus generate and deliver video content (game screen) of higher quality than that rendered by the client 400 in client-side rendering. High-quality video content may be high-resolution video content, high-frame-rate video content, or high-resolution and high-frame-rate video content.

The video content generated by rendering in the second virtual space 200 may be static content or dynamic content that is available to a specific player.

When generating the static content, the second virtual space 200 does not have interactivity because the content is delivered unilaterally to the player and viewers. On the other hand, when generating the dynamic content, the second virtual space 200 has interactivity because the player makes input on the basis of the delivered content.

The second virtual space 200 may be configured with an on-premises server or may be configured with a server such as a public cloud server. In the present embodiment, it is assumed that the second virtual space 200 is configured as a virtual server capable of dynamically allocating computing resources.

The second virtual space 200 is able to render and generate the game screen as more advanced video content by integrating sensing data acquired by sensing the real world with the sensor 600 pre-arranged as necessary, with the spatial information from the first virtual space 100. Examples of integrating the sensing data with the spatial information include causing a rainfall in the game space in a case where the acquired sensing data indicates that it is raining in the real world, turning the game space into a night in a case where the acquired sensing data indicates that the real world is in a dark night, and displaying, for example, viewers' comments and chats in the game space or reflecting them in the game.

The second virtual space 200 streams the game screen by using, for example, a CDN (Contents Delivery Network) depending on the type of content (static content or dynamic content).

The CDN is a network for delivering various types of content, such as video content, games, live content, and websites, by using distributed cache servers. In the CDN, the client 400 and the viewer terminal 500 acquire the content from the cache servers provided by the CDN. This reduces the load on the second virtual space 200 and the network that are used to provide the content.

The information processing device 300 monitors the first virtual space 100, and in a case of detecting a trigger predefined in a table, launches an instance (virtual server) for operating the second virtual space 200. A configuration of the information processing device 300 will be described later.

The client 400 is a terminal that is used by a player who plays the multi-online game, and may be, for example, a video game console, a handheld game console, a personal computer, a smartphone, or a tablet computer.

The viewer terminal 500 is a terminal used by a viewer who does not play the multi-online game but simply watches the streamed game. The viewer terminal 500 may be, for example, a video game console, a handheld game console, a personal computer, a smartphone, or a tablet computer.

### 1-2. Configuration of Information Processing Device 300

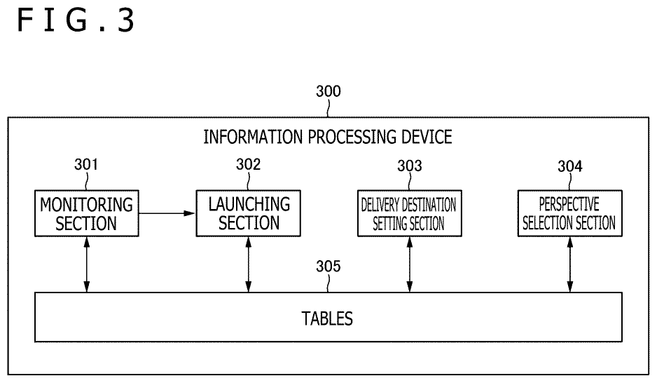

The configuration of the information processing device 300 will now be described with reference to FIG. 3. The information processing device 300 includes a monitoring section 301, a launching section 302, a delivery destination setting section 303, a perspective selection section 304, and tables 305.

The monitoring section 301 communicates with the dedicated game server which is the first virtual space 100, and monitors whether or not a predefined trigger is detected. It is assumed that the monitoring section 301 uses, for example, an RPC and a gRPC over HTTP, HTTP2, or HTTP3.

The launching section 302 launches the instance (virtual server) for operating the second virtual space 200 in a case where the monitoring section 301 detects the trigger. Program code (e.g., daemon) on the instance for operating the second virtual space 200 constructs the game space to be processed in the second virtual space 200.

Incidentally, construction means, for example, determining the status and arrangement of avatars and objects in the game on the basis of the snapshot and spatial information from the first virtual space 100. Rendering the game screen as video content is performed in the second virtual space 200 on the basis of the result of such determination.

Further, the launching section 302 performs processing to scale out resources for constructing the second virtual space 200.

In a case where the content generated by rendering in the second virtual space is static content, the delivery destination setting section 303 sets the destination to which such content is to be delivered.

The perspective selection section 304 selects any specific one of multiple perspectives as a new rendering perspective in a case where perspective switching is to be performed at the time of rendering of video content in the second virtual space 200.

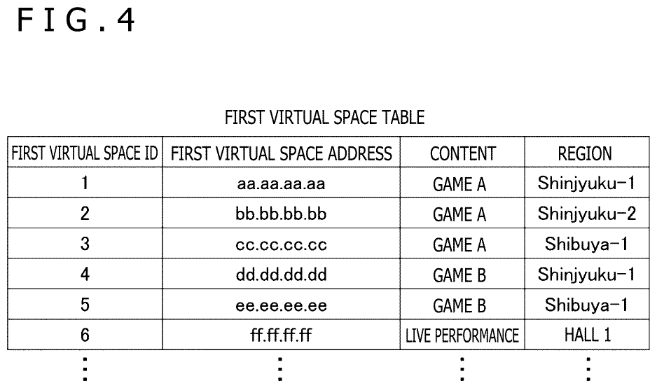

The tables 305 are preset to allow the information processing device 300 to perform processing. As depicted in FIGS. 4 to 12, the tables include a first virtual space table, a content table, a trigger table, a second virtual space table, a sensor table, a delivery destination table, a rendering table, a perspective table, and a perspective selection parameter table.

The first virtual space table depicted in FIG. 4 manages an address where the first virtual space 100 is constructed, the type of content, and a region in association with each other. The type of content includes a virtual live performance and a metaverse in addition to a multi-online game.

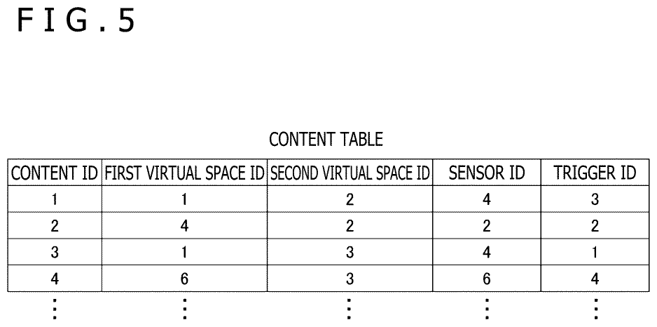

The content table depicted in FIG. 5 manages a first virtual space ID, a second virtual space ID, a sensor ID, and a trigger ID in association with each other.

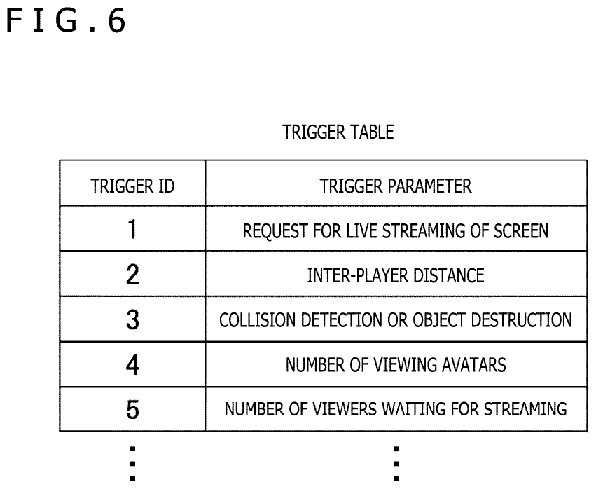

The trigger table depicted in FIG. 6 manages multiple preset triggers that act as triggers for launching an instance that operates the second virtual space 200. In the present embodiment, the preset triggers are a request for streaming, an inter-avatar distance, a collision detection or object destruction, the number of views, and the number of viewers waiting for streaming.

The request for streaming is a request for streaming the video of a game played by a player. In recent years, gameplay is frequently streamed over the Internet. Therefore, there is a demand for players to stream the video of games that they are playing.

The inter-avatar distance is the distance between the avatar of a player in a game and the avatar of another player in the game. In the multi-online game, when the avatars approach each other, an event, such as a battle, occurs. Therefore, there is a demand to start streaming the video of the game at the time when the avatars approach each other. Accordingly, the inter-avatar distance is used as a trigger so as to automatically render the game screen in the second virtual space 200 in a case where the inter-avatar distance is shorter than a predetermined distance. Using the inter-avatar distance as a trigger makes it possible to, for example, generate highlight video of car overtaking scenes in a racing game in addition to highlight video of battles. When the inter-avatar distance is long, that is, while there is no event such as a battle, the game screen is not rendered in the second virtual space 200. This makes it possible to avoid unnecessary resource consumption. The inter-avatar distance can be calculated on the basis of the coordinates of the avatars included in a snapshot.

The collision detection is the detection of a contact or attack in a game that has occurred between a player's avatar and another player's avatar. In the multi-online game, the contact between the avatars causes an event such as a battle. Therefore, there is a demand to start streaming the video of the game at the time when the avatars contact each other. Accordingly, the collision detection is used as a trigger so as to automatically render the game screen in the second virtual space 200 when the avatars contact each other. The object destruction is the destruction of an object in the game that is performed by a player's avatar. Using the object destruction as a trigger automatically renders the game screen in the second virtual space 200 when a player's avatar destroys the object to start an event. It is assumed that the collision detection can be achieved on the basis of the coordinates of the avatar included in the snapshot, and that the object destruction can be detected on the basis of information regarding an object description included in the snapshot.

The number of viewing avatars is the number of avatars of players who watch, for example, expressive activities of the avatar of a certain other player in a virtual live performance hall or a metaverse. In a case where expressive activities are being performed in the virtual live performance hall or the metaverse and where the number of viewing avatars is equal to or more than a predetermined number (the number of views is large), there is a demand to stream live video or highlight video. Accordingly, the number of viewing avatars is used as a trigger so as to render and stream the video content in the second virtual space 200 in a case where there are many viewers. In a case, for example, where multiple avatars gather at a specific location in the first virtual space 100, the number of viewing avatars can be detected by counting the number of such avatars. Further, in a case where the number of viewing avatars is small, unnecessary resource consumption can be avoided by not constructing the second virtual space 200.

The number of viewers waiting for streaming is the number of viewers who are waiting for a player's delivery. In a case where the number of viewers waiting for streaming is equal to or more than a predetermined number, there is a demand to stream live video or highlight video. Accordingly, the number of viewers waiting for streaming is used as a trigger so as to render and stream the video content in the second virtual space 200 in a case where there are many viewers waiting for streaming. In a case where the number of viewers waiting for streaming is small, unnecessary resource consumption can be avoided by not rendering the video content in the second virtual space 200. In a case, for example, where multiple avatars gather at a specific location in the virtual live performance hall or the metaverse, the number of viewing avatars can be detected by counting the number of such avatars.

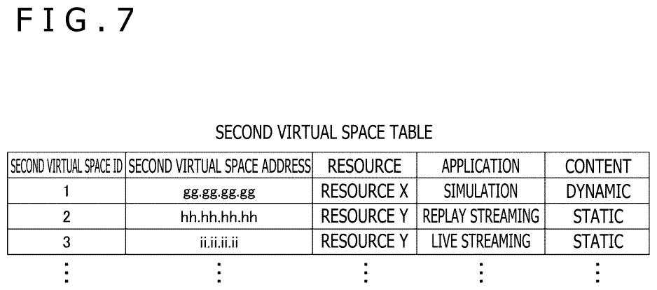

The second virtual space table depicted in FIG. 7 manages an address where the second virtual space 200 is constructed, the type of content, a resource used for constructing the second virtual space 200, and an application in association with each other. The type of content includes static content and dynamic content.

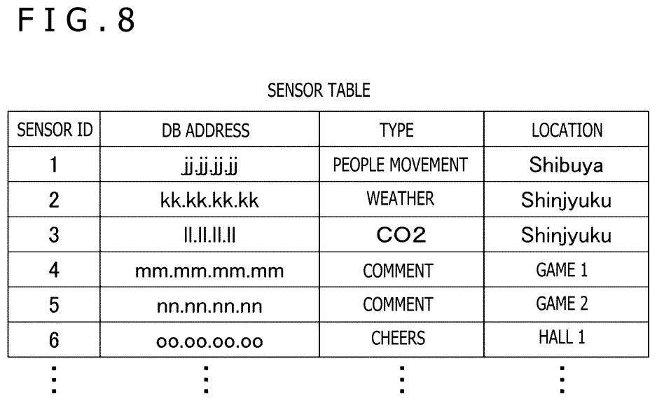

The sensor table depicted in FIG. 8 manages the address of a database for aggregating the sensing data, the type of sensor 600, and the location for sensing data collection in association with each other.

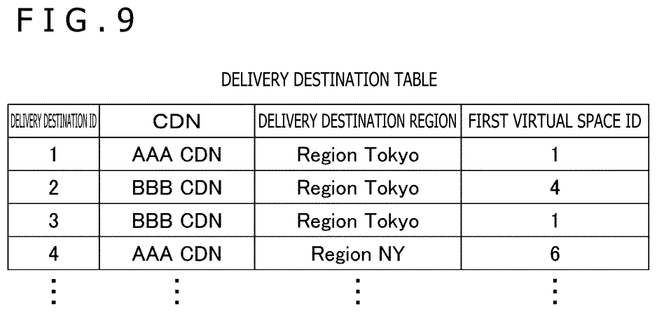

The delivery destination table depicted in FIG. 9 manages the type of CDN used for delivery of static content generated in the second virtual space 200, a delivery destination region, and the first virtual space ID in association with each other.

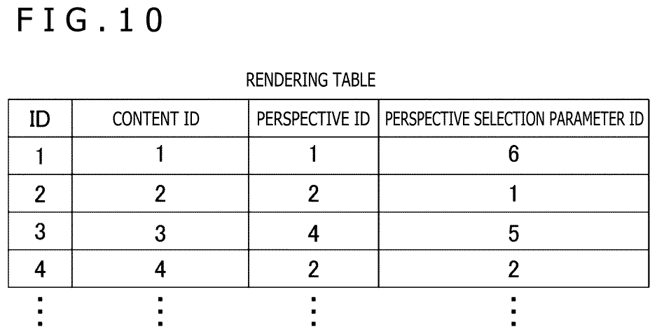

The rendering table depicted in FIG. 10 is a table for linking a rendering perspective to content in the second virtual space 200, and manages the combination of a content ID, a perspective ID of the second virtual space 200, and a perspective selection parameter ID.

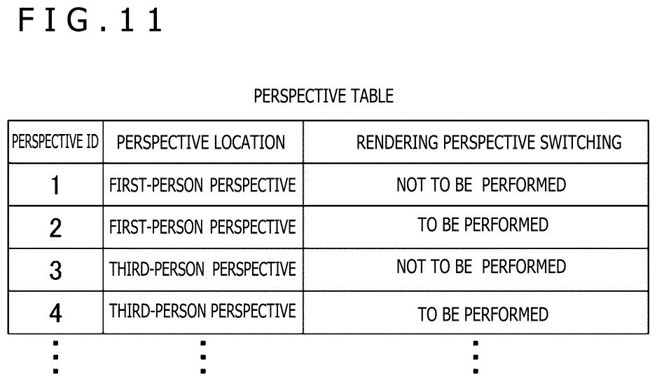

The perspective table depicted in FIG. 11 manages, in association with each other, a perspective (first-person perspective or third-person perspective) for rendering the game screen in the second virtual space 200 and whether or not perspective switching is to be performed at the time of rendering. For example, in a game related to content with an ID of 3, the third-person perspective is selected as the perspective location, and the perspective switching is set to be performed.

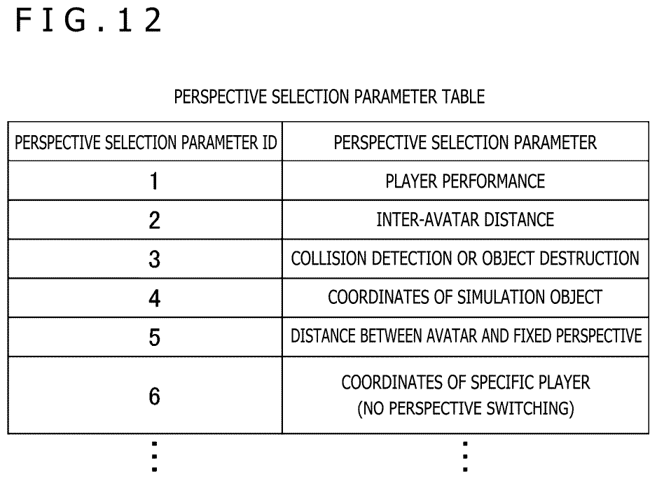

The perspective selection parameter table depicted in FIG. 12 manages parameters that act as criteria by which the perspective selection section 304 selects a perspective for rendering perspective switching at the time of rendering the game screen in the second virtual space 200.

It should be noted that the contents of the tables depicted in FIG. 4 to FIG. 12 are merely examples for explaining the present embodiment. The present technology is not limited to such contents of the tables.

The information processing device 300 is configured as described above. In the present embodiment, the information processing device 300 may be configured in an on-premises server or a server such as a public cloud server, the functions of the information processing device 300 may be incorporated in advance in an electronic device, such as a server or a personal computer, and the information processing device 300 and the information processing method may be implemented by causing the electronic device to execute a program. The program may be preinstalled in the electronic device, or may be downloaded or distributed, for example, on a storage medium and installed, for example, by an operator of the multi-online game. Alternatively, the information processing device 300 may be configured as a standalone device.

### 1-2. Processes in Content Delivery System 10 and Information Processing Device 300

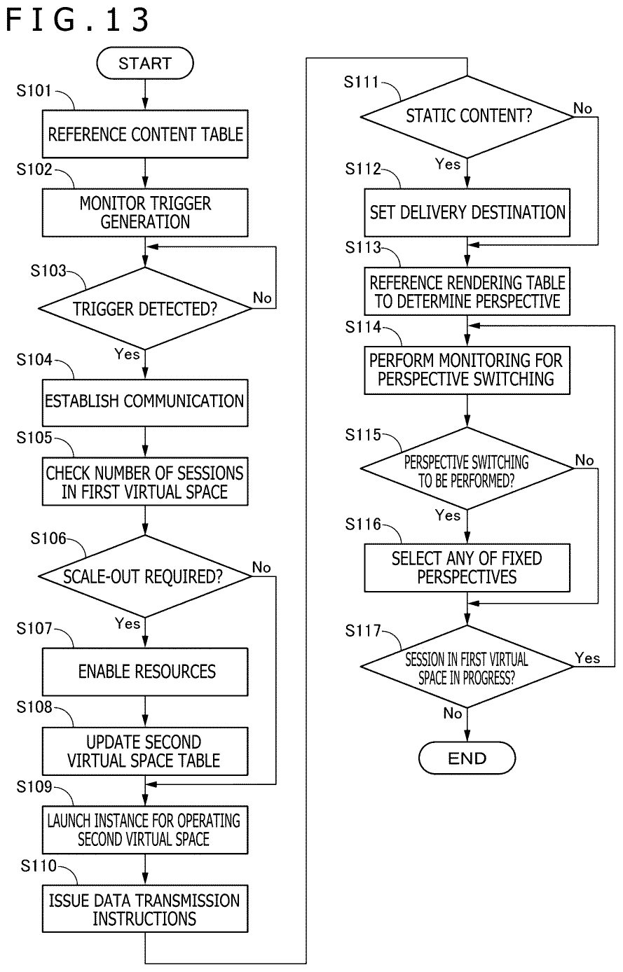

Processes performed in the content delivery system 10 and the information processing device 300 will now be described with reference to FIGS. 13 to 19. The present embodiment is described below with reference to an example in which a player plays the multi-online game from the first-person perspective by using the client 400 for client-side rendering and streams the game screen, that is, the video content obtained by rendering in the second virtual space 200, to the viewers.

It is assumed that the respective tables depicted in FIG. 4 to 12 are preset in the information processing device 300.

Further, it is assumed that the player plays a “game A” registered in the first virtual space with an ID of 1 in the first virtual space table depicted in FIG. 4 and uses the dedicated server for a “Shinjuku-1” region. Additionally, it is also assumed that the player requests the live streaming of the game screen generated by rendering in the second virtual space 200 during the game played. The request for such live streaming can be made, for example, by the player who makes input to a video game console controller or smartphone that acts as the client 400. Information inputted for requesting such live streaming is included in the snapshot transmitted from the first virtual space 100 to the information processing device 300.

First, in step S101, the monitoring section 301 references the content table depicted in FIG. 5. As described above, the player is playing the game A by using the dedicated server for the “Shinjuku-1” region, which is the first virtual space with an ID of 1 in the first virtual space table. Therefore, the corresponding content in the content table is the content with an ID of 1 or the content with an ID of 3.

Next, in step S102, the monitoring section 301 references the trigger table depicted in FIG. 6 to monitor the generation of a trigger in the first virtual space 100.

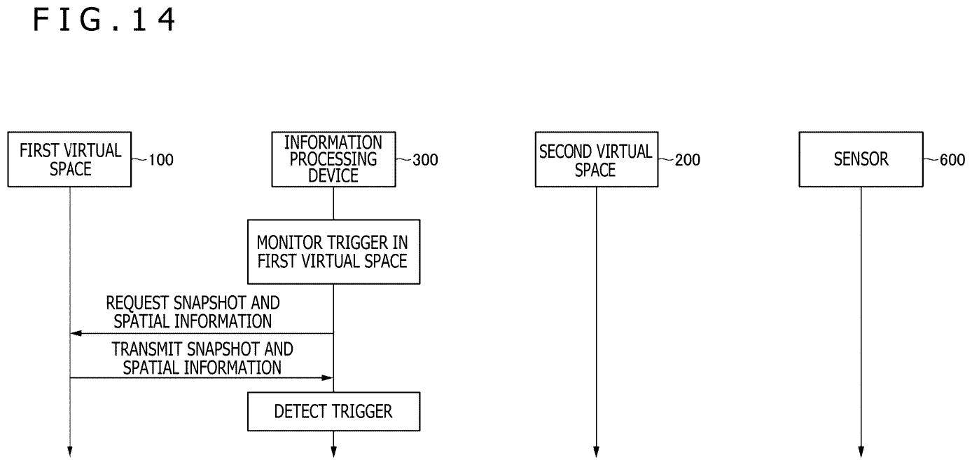

For monitoring the trigger, as depicted in FIG. 14, the information processing device 300 requests the first virtual space 100 to transmit the snapshot and the spatial information.

When, in response to the above request, the first virtual space 100 transmits the snapshot and the spatial information to the information processing device 300, the information processing device 300 acquires them and detects a trigger included in the snapshot or spatial information.

In the present embodiment, as described above, the player requests the live streaming of the game screen generated in the second virtual space 200 during the game played. Therefore, the trigger with an ID of 1 in the trigger table is detected, and the process proceeds from step S103 to step S104 (Yes in step S103).

Further, since the trigger with an ID of 1 is detected by monitoring, the second virtual space with an ID of 3 and the sensor with an ID of 4 can be identified on the basis of the content with an ID of 3, which corresponds to the first virtual space with an ID of 1 and the trigger with an ID of 1 in the content table. In this manner, the content table makes it possible to identify the second virtual space ID and the sensor ID on the basis of the first virtual space ID and the trigger ID.

Next, in step S104, the information processing device 300 establishes communication with the server identified by the second virtual space with an ID of 3 in the second virtual space table depicted in FIG. 7 and communication with the sensor 600 identified by the sensor with an ID of 4 in the sensor table depicted in FIG. 8. In the present embodiment, the sensor with an ID of 4 is identified. Therefore, the sensor 600 is a sensor for acquiring data regarding the comments (e.g., text chats and viewers' comments during the game) in the game A.

Next, in step S105, the launching section 302 checks the number of sessions between the first virtual space 100 and the client 400. In a case where the number of sessions in the first virtual space 100 is equal to or more than a predetermined number, the launching section 302 performs scaling and determines that it is necessary to scale out the resources for constructing the second virtual space 200. Consequently, the process proceeds from step S106 to step S107 (Yes in step S106). Then, in step S107, new resources of the instance for constructing the second virtual space 200 are enabled.

A session is a series of communications from the start to the end of an access from the client 400 to the first virtual space 100. The number of sessions increases in a case where the multi-online game is played by many players. When there are many sessions, preset resources may possibly be insufficient to construct the second virtual space 200. If such a situation arises, the resources are strengthened or different resources are used to enable resources for constructing the second virtual space 200.

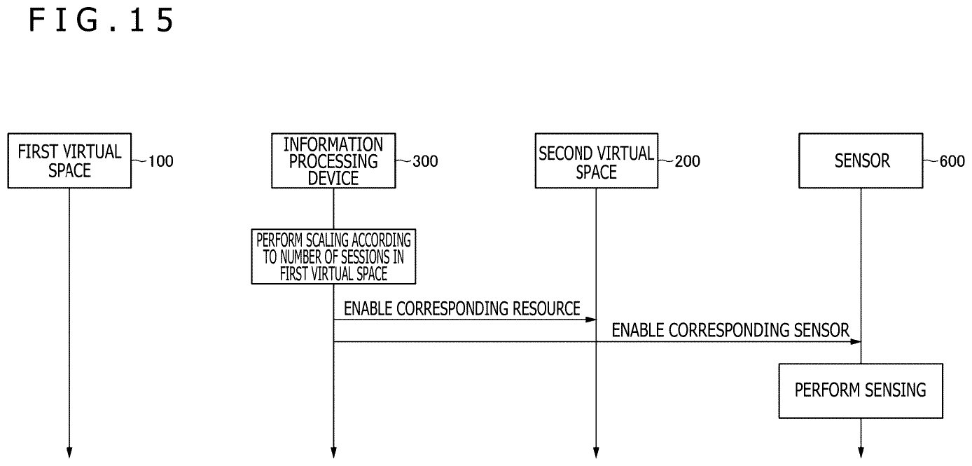

In a case where a scale-out is to be performed, as depicted in FIG. 15, the information processing device 300 transmits instructions and information for enabling the resources and scaling out.

Further, as depicted in FIG. 15, the information processing device 300 transmits instructions for enabling the sensor 600 to perform sensing. Upon receiving the instructions, the sensor 600 performs sensing.

After enabling the resources for constructing the second virtual space 200, the information processing device 300 proceeds to step S108 and updates the resource field for the second virtual space with an ID of 3 in the second virtual space table.

Next, in step S109, the launching section 302 launches the instance for operating the second virtual space 200. The program code on the instance for operating the second virtual space 200 constructs the game space to be processed in the second virtual space 200.

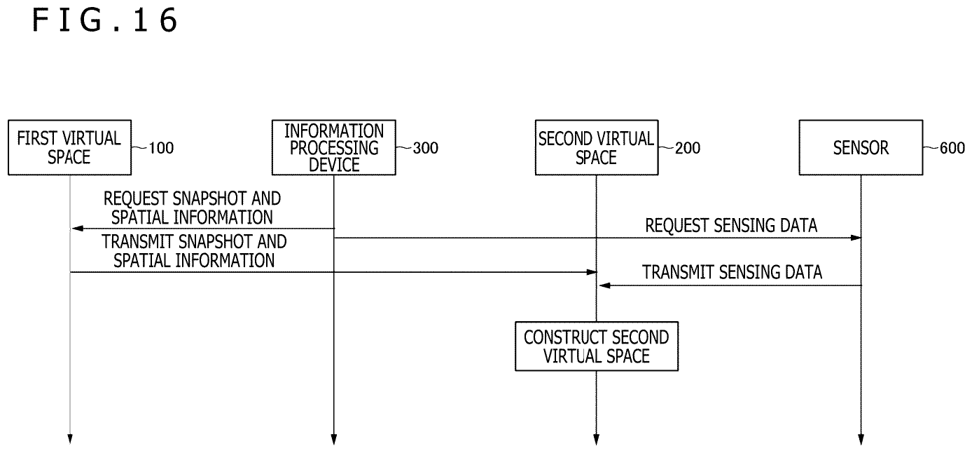

Next, in step S110, the information processing device 300 requests the first virtual space 100 and the sensor 600 to transmit data for constructing the second virtual space 200. The request for data transmission is depicted in FIG. 16. The second virtual space 200 is constructed by allowing the instance for operating the second virtual space 200 to use the snapshot and spatial information transmitted from the first virtual space 100 and the sensing data transmitted from the corresponding sensor 600. Therefore, as depicted in FIG. 16, the information processing device 300 requests the first virtual space 100 identified by the content table depicted in FIG. 5, to transmit the snapshot and spatial information for constructing the second virtual space 200. In response to the above request, the first virtual space 100 transmits the snapshot and the spatial information to the instance for operating the second virtual space 200.

Further, the information processing device 300 requests the sensor 600 identified by the content table depicted in FIG. 5, to transmit the sensing data for constructing the second virtual space 200. Then, upon receiving such a request, the sensor 600 transmits the sensing data to the instance for operating the second virtual space 200.

Subsequently, the instance for operating the second virtual space 200 constructs the second virtual space 200 by using the snapshot and spatial information from the first virtual space 100 and the sensing data from the sensor 600. For example, a known server technology is used to construct a virtual server acting as the second virtual space 200 by use of a hypervisor configured to operate on a physical server.

Next, in step S111, the delivery destination setting section 303 references the second virtual space table depicted in FIG. 7 to check whether static content or dynamic content is displayed on the game screen, which displays the video content generated by rendering in the constructed second virtual space 200. In the present embodiment, this matter relates to the second virtual space with an ID of 3 in the second virtual space table. Therefore, the video content displayed on the game screen is static content. In a case where the content is static content, the process proceeds to step S112 (Yes in step S111).

Next, in step S112, the delivery destination setting section 303 references the delivery destination table depicted in FIG. 9 to set the region closest to the first virtual space 100 as the destination of static content generated in the second virtual space 200. Setting the region closest to the first virtual space 100 as the delivery destination is based on the expectation that both the player and content viewers will access the region closest to the first virtual space 100 in order to view the content.

On the other hand, in a case where the content generated in the second virtual space 200 is dynamic content, the content is streamed to the client 400 from the second virtual space 200, which functions as a streaming server.

The content is delivered no matter whether the content generated in the second virtual space 200 is static content or dynamic content. In the case of the static content, it is delivered by using the CDN. On the other hand, in the case of the dynamic content, it is delivered from the second virtual space 200 to the client 400 without using the CDN; therefore, the information processing device 300 transmits region information regarding a dynamic content delivery destination to the second virtual space 200.

Next, in order to generate the game screen by rendering in the second virtual space 200, in step S113, the perspective selection section 304 references the rendering table depicted in FIG. 10 to identify the perspective ID and perspective selection parameter ID for rendering in the second virtual space 200. In the present embodiment, the content with an ID of 3 is identified in the content table; therefore, the perspective with an ID of 4 and the perspective selection parameter with an ID of 5 are identified from the rendering table.

A player playing a first-person perspective multi-online game is usually able to view the game screen only from the perspective of his or her own avatar (first-person perspective). However, when the game screen is generated by rendering from the third-person perspective in the second virtual space 200, the player is able to objectively view his or her own play, including the appearance of his or her avatar, and stream the game screen from the third-person perspective.

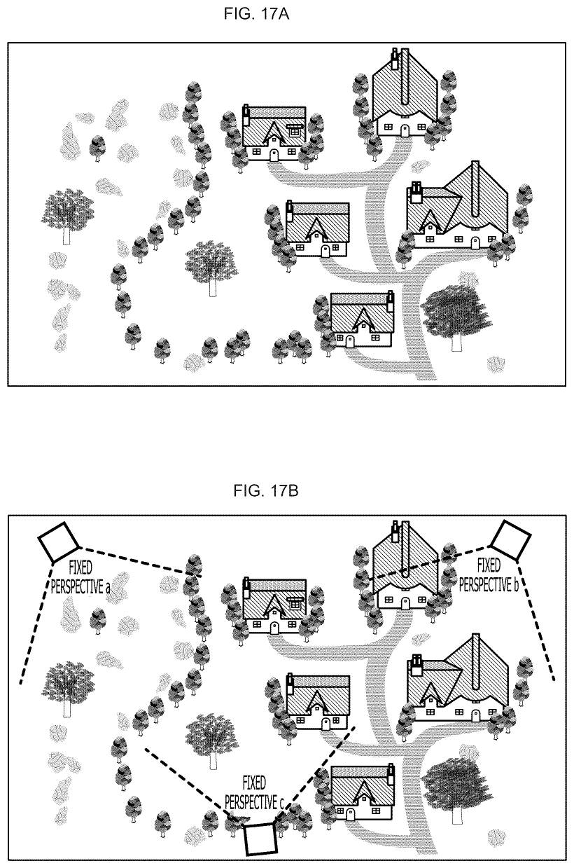

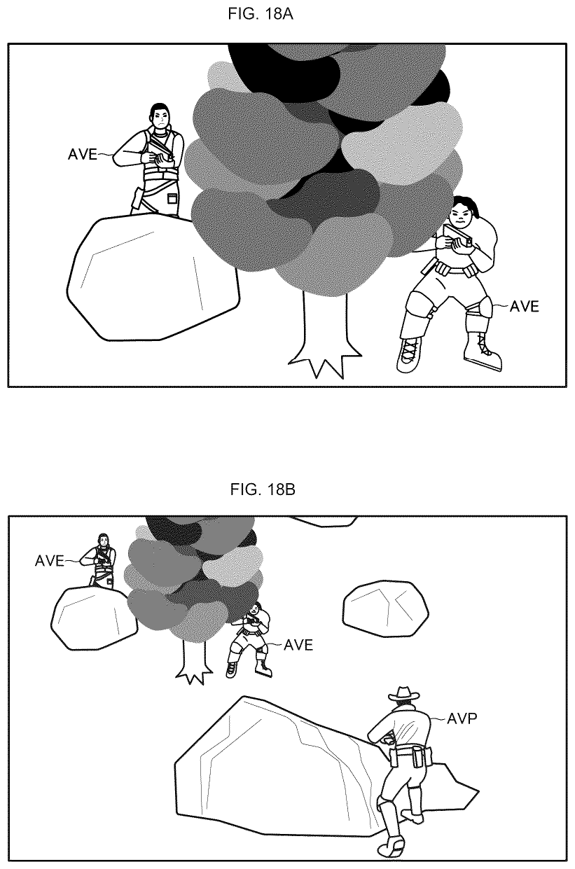

In the perspective table depicted in FIG. 11, the perspective with an ID of 4 is a third-person perspective. It is assumed that fixed perspective coordinates are used as the coordinates of the rendering perspective in the second virtual space 200. Therefore, the rendering perspective is set as a fixed third-person perspective. In a case, for example, where the map of the game space constructed by the first virtual space 100 is as depicted in FIG. 17A, the multi-online game being played by the player is a first-person perspective game. Consequently, a first-person perspective game screen is displayed in the client 400 as depicted in FIG. 18A. Since the game screen is as viewed from the first-person perspective, the player's avatar is not drawn, and avatars AVE of opposing players are drawn from the perspective of the player's avatar.

Subsequently, as depicted in FIG. 17B, multiple fixed perspectives are preset on the map of the game in the second virtual space 200 on the basis of the map data and terrain data included in the spatial information received from first virtual space 100. Three fixed perspectives, namely, a fixed perspective a, a fixed perspective b, and a fixed perspective c, are set in FIG. 17B. The three fixed perspectives are set for illustrative purposes only, and the number of fixed perspectives may be three or more, or may be three or less.

In a case where a fixed perspective is used for rendering in the second virtual space 200, the fixed perspective acting as a rendering perspective is predefined in this manner. This allows for higher-spec GPU processing than the first virtual space 100. Consequently, many resources can be allocated to game screen rendering. As a result, it is possible to generate and stream the game screen of higher quality than that rendered by client-side rendering performed by the client 400. A high-quality game screen may be achieved by a high-resolution game screen, by a high-frame-rate game screen, or by a high-resolution, high-frame-rate game screen.

Further, a perspective selection parameter with an ID of 5 in the perspective selection parameter table depicted in FIG. 12 is a “distance between avatar and fixed perspective.” Therefore, the rendering perspective for rendering the game screen in the second virtual space 200 is selected from among multiple fixed perspectives by using the distance between the avatar operated by the client 400 and each fixed perspective as a reference.

Next, in step S114, the perspective selection section 304 performs monitoring for synchronization between the first virtual space 100 and the second virtual space 200 and for dynamic switching of the rendering perspective. For synchronization between the first virtual space 100 and the second virtual space 200, the perspective selection section 304 manages the periodic transmission of the snapshot and spatial information including, for example, avatar coordinate data and status, from the first virtual space 100 to the second virtual space 200. In a case where switching of the rendering perspective is to be performed, the process proceeds from step S115 to step S116 (Yes in step S115).

Synchronization between the first virtual space 100 and the second virtual space 200 is achieved by repeating the request for the snapshot and spatial information from the information processing device 300 to the first virtual space 100 and the transmission of the snapshot and spatial information from the first virtual space 100 to the second virtual space 200 until the end of the session in the first virtual space 100. Monitoring of synchronization is performed by monitoring parameter value changes in a perspective selection parameter transmission from the second virtual space 200 to the information processing device 300, that is, monitoring whether the second virtual space 200 is being updated along with the temporal changes in the first virtual space 100.

In a case where the perspective ID corresponding to the content ID in the rendering table indicates in the perspective table that “rendering perspective switching” is “not to be performed,” no rendering perspective switching occurs, so that the answer to the query in step S115 is No. Further, even when the perspective table indicates that “rendering perspective switching” is “to be performed,” in a case, for example, where the perspective selection parameter is the “distance between avatar and fixed perspective” and where the avatar does not move at all, no perspective switching occurs (perspective switching need not be performed). In this case, therefore, the answer to the query in step S115 is No. On the other hand, in a case where the perspective ID corresponding to the content ID in the rendering table indicates in the perspective table that “rendering perspective switching” is “to be performed,” the answer to the query in step S115 is Yes. In the present embodiment, the perspective ID is 4, so that “rendering perspective switching” is “to be performed.”

In the case of switching the rendering perspective, the perspective selection section 304 selects, in step S116, the perspective to be used as the rendering perspective from among the perspectives of an avatar, character, or object in the second virtual space 200 or multiple fixed perspectives preset in the game space, and updates the rendering perspective. The updated rendering perspective becomes the rendering perspective after switching.

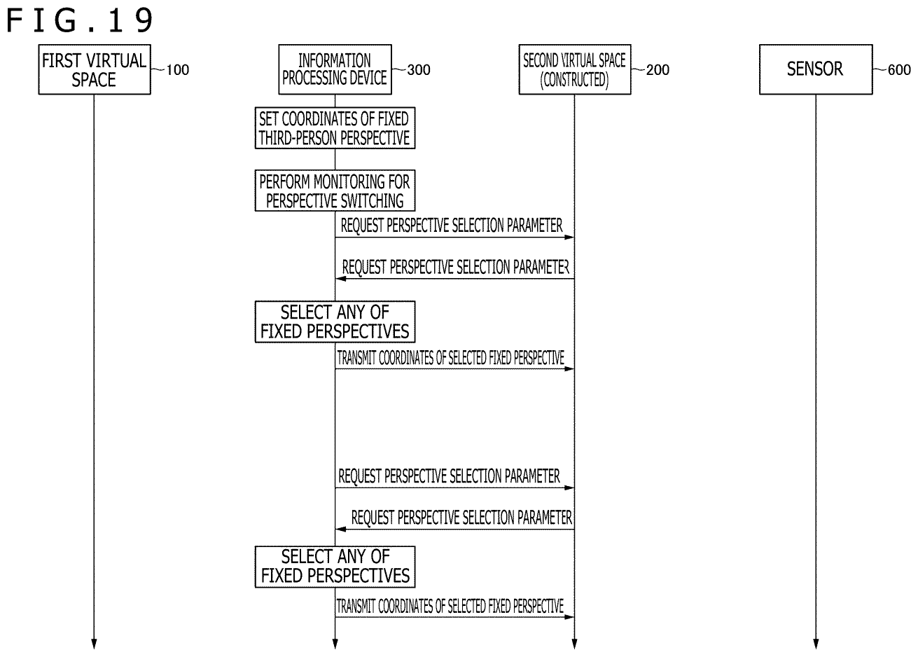

After setting the coordinates of multiple fixed third-person perspectives on the map of the game space in the second virtual space 200 as depicted in FIG. 17B, the information processing device 300 requests the second virtual space 200 to transmit a perspective selection parameter as depicted in FIG. 19. In response to the above request, the second virtual space 200 transmits the perspective selection parameter to the information processing device 300. As described above, the perspective selection parameter in the present embodiment is the “distance between avatar and fixed perspective.” Therefore, the second virtual space 200 transmits information regarding the distance between the avatar and each fixed perspective to the information processing device 300 as the perspective selection parameter.

The perspective selection section 304 then selects a fixed perspective for providing the shortest distance to the avatar from among multiple fixed perspectives set on the map of the game space, and causes the information processing device 300 to transmit the coordinates of the selected fixed perspective to the second virtual space 200. The second virtual space 200 performs rendering by using the selected fixed perspective as the rendering perspective, and generates the game screen. This results in the switching of the perspective of the game screen. Accordingly, even when the player's avatar moves, it is possible to generate a new game screen that constantly displays the player's avatar. In the manner described above, the information processing device 300 switches the rendering perspective on the basis of location information and event information in the form of perspective selection parameters.

In a case, for example, where the player's avatar is in the upper left area of the map depicted in FIG. 17B and where the distance between the avatar and the fixed perspective is the shortest, the fixed perspective a is used as the rendering perspective to render the game screen in the second virtual space 200. In a case where the avatar subsequently moves to the upper right area and the distance between the avatar and hence the fixed perspective b is the shortest, the above-mentioned step S116 is performed to select the fixed perspective b from among multiple fixed perspectives, so that the rendering perspective is switched from the fixed perspective a to the fixed perspective b. The second virtual space 200 performs rendering and generates the game screen by using the fixed perspective selected by switching as the rendering perspective, and is thus able to generate a third-person perspective game screen that constantly displays the player's avatar irrespective of perspective switching, as depicted in FIG. 18B. Since a game screen as viewed from the third-person perspective is depicted in FIG. 18B, a player's avatar AVP and the avatars AVE of opposing players are drawn. As described above, the second virtual space 200 switches the rendering perspective to the fixed perspective selected by the information processing device 300, and then renders the game screen.

After perspective switching, the information processing device 300 checks in step S117 whether or not the session in the first virtual space 100 is in progress. In a case where the session in the first virtual space 100 is in progress, the process proceeds to step S114, and repeats steps S114 to S117 as long as the session is in progress (Yes in step S117). On the other hand, in a case where the session in the first virtual space 100 is not in progress, the update of the corresponding second virtual space 200 is terminated to close the virtual space and end the process (No in step S117).

The process according to the present embodiment is performed as described above. According to the present technology, upon detecting a trigger in the first virtual space 100 involving interactions with multiple players, the information processing device 300 launches an instance for operating the second virtual space 200 that is capable of generating high-quality content.

Further, the snapshot and the spatial information in the first virtual space 100 are transmitted to the second virtual space 200. The second virtual space 200 then performs rendering from a predefined perspective on the basis of such information and streams the video content resulting from rendering to the player, other players, viewers, etc., who are engaged in interaction in the first virtual space 100.

In a case where a fixed perspective is used for rendering, the second virtual space 200 is scaled according to the number of sessions in the first virtual space 100. The second virtual space 200 is configured to limit the number of fixed perspectives used as rendering perspectives and is thus capable of performing higher-spec GPU processing than the first virtual space 100. In a case where a perspective of an avatar, character, or object is used for rendering, the second virtual space 200 is scaled according to the number of sessions in the first virtual space 100 and is thus capable of performing higher-spec GPU processing than the first virtual space 100.

This makes it possible to allocate many resources to game screen rendering, and generate and stream the game screen of higher quality than that rendered by client-side rendering performed by the client 400. As a result, a new video experience can be provided to the players and viewers by using, for example, high-quality video and video rendered from a new perspective.

When information obtained from the real space through the use of the sensor 600 at the time of launching an instance for operating the second virtual space 200 is combined with object information from the first virtual space 100, it is possible to improve the quality of the content generated in the second virtual space 200 and additionally improve the sense of presence and reality of the content. Consequently, the high-quality content additionally includes video content to which information acquired by the sensor 600 is added.

The first virtual space 100 is applicable to games, virtual live performances, metaverses, and other events involving interactions between many players and, at the same time, capable of providing the same type of content of different qualities for specific purposes by generating and delivering high-quality content with a limited number of perspectives in the second virtual space 200 on the basis of information from the first virtual space 100.

Further, according to the number of sessions in the first virtual space 100, the information processing device 300 scales out the resources for launching an instance for operating the second virtual space 200. Therefore, the information processing device 300 is able to allocate appropriate resources to the launching of the instance for operating the second virtual space 200.

Moreover, when the CDN is used to deliver and cache static content, it is possible to reduce the load on the processing for content delivery in the second virtual space 200 and decrease the number of renderings in the client 400 and the viewer terminal 500.

### 2. Modifications

The embodiment of the present technology has been described in detail above. However, the present technology is not limited to the foregoing embodiment, and various modifications can be made on the basis of the technical idea of the present technology.

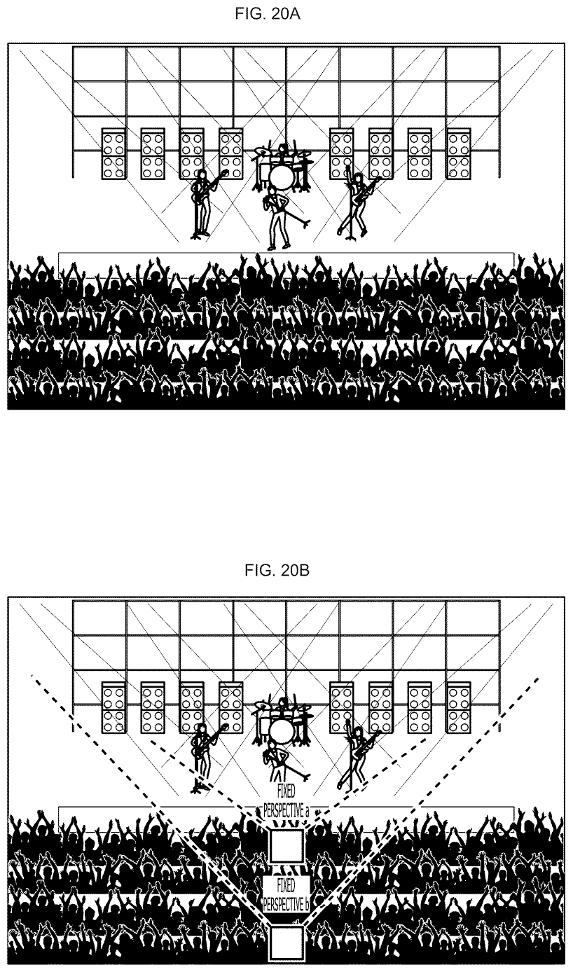

The foregoing embodiment has been described by using a multi-online game as an example. However, the present technology is applicable not only to the multi-online game but also to content such as a virtual live performance and a metaverse. When the present technology is applied to a virtual live performance, in a case where the space for the virtual live performance is as depicted, for example, in FIG. 20A and where rendering is performed from a fixed perspective, multiple fixed perspectives depicted, for example, in FIG. 20B are to be set as the rendering perspectives. The rendering perspectives may be first-person perspectives such as those of viewers.

Further, the present technology can also be used in various situations in the real world, such as airplane flight simulations and automobile driving simulations. In such a case, high-quality video content for simulation is generated by performing rendering in the second virtual space 200. In such an instance, higher-quality video content can be generated by adding, for example, weather information acquired by the sensor 600 to the video content to be rendered in the second virtual space 200. For example, in a case where it is raining in the real world, it is possible to cause rain in the video content as well.

The foregoing embodiment has been described with reference to an example in which the game screen generated on the basis of information from the first virtual space 100 has a first-person perspective while the game screen generated by the second virtual space 200 has a third-person perspective. However, the game screen generated on the basis of the information from the first virtual space 100 may have a third-person perspective, and the game screen generated by the second virtual space 200 may have a first-person perspective. Moreover, the game screen generated on the basis of the information from the first virtual space 100 and the game screen generated by the second virtual space 200 may both have a first-person perspective or a third-person perspective.

The foregoing embodiment has been described on the assumption that the fixed perspective is a perspective preset in the second virtual space 200 and selected as the rendering perspective. However, the rendering perspective selected in the above manner is not limited to the fixed perspective, and may be a dynamically changing perspective.

The foregoing embodiment has been described on the assumption that the content to be refined is a game screen displayed as video content. However, the content to be refined is not limited to the video content, and the present technology can also be applied to still image content.

The present technology may additionally adopt the following configurations.
(1)

An information processing device including:
a monitoring section configured to detect a predefined trigger on the basis of a snapshot from a first virtual space acting as a dedicated server; and
a launching section configured to launch, in a case where the monitoring section detects the trigger, an instance for operating a second virtual space that acts as a dedicated server different from the first virtual space and that renders and generates content.
(2)

The information processing device according to (1), in which the information processing device selects, as a perspective for rendering in the second virtual space, any of multiple perspectives preset in a space constructed by the second virtual space.
(3)

The information processing device according to (2), in which the information processing device selects any of the multiple perspectives on the basis of a perspective selection parameter transmitted from the second virtual space.
(4)

The information processing device according to (2), in which the second virtual space renders and generates video content by using, as a rendering perspective, a perspective selected from among the multiple perspectives.
(5)

The information processing device according any of (1) to (4),
in which the second virtual space generates content of high quality compared to content generated on the basis of information from the first virtual space.
(6)

The information processing device according to (5),
in which the content of high quality includes video content of high resolution.
(7)

The information processing device according to (5) or (6),
in which the content of high quality includes video content of high frame rate.
(8)

The information processing device according to any of (5) to (7),
in which the content of high quality includes content to which information acquired by a sensor is added.
(9)

The information processing device according to any of (1) to (8),
in which, in a case where the number of sessions between the first virtual space and a client to which the content is provided is equal to or more than a predetermined number, the information processing device scales out resources for constructing the second virtual space.
(10)

The information processing device according to any of (1) to (9),
in which the content generated by the second virtual space includes video content that is rendered from a different person's perspective other than that for content generated on the basis of information from the first virtual space.
(11)

The information processing device according to (10),
in which, in a case where the content generated on the basis of the information from the first virtual space includes content viewed from a first-person perspective, the content generated by the second virtual space includes video content viewed from a third-person perspective.
(12)

The information processing device according to any of (1) to (11),
in which the content generated by the second virtual space is delivered through a CDN (Content Delivery Network).
(13)

The information processing device according to any of (1) to (12),
in which, in a case where the content generated by the second virtual space includes static content, the information processing device sets a region closest to the first virtual space as a delivery destination for the content.
(14)

The information processing device according to any of (1) to (13),
in which the first virtual space acts as a dedicated game server.
(15)

The information processing device according to any of (1) to (14),
in which the second virtual space acts as a dedicated game server that further has rendering and streaming capabilities.
(16)

An information processing method including:
detecting a predefined trigger on the basis of a snapshot from a first virtual space acting as a dedicated server; and
launching, in a case where the trigger is detected, an instance for operating a second virtual space that acts as a dedicated server different from the first virtual space and that renders and generates content.
(17)

A program for causing a computer to execute an information processing method including
detecting a predefined trigger on the basis of a snapshot from a first virtual space acting as a dedicated server; and
launching, in a case where the trigger is detected, an instance for operating a second virtual space that acts as a dedicated server different from the first virtual space and that renders and generates content.
(18)

A content delivery system including:
a first virtual space that acts as a dedicated server;
a second virtual space that acts as a dedicated server different from the first virtual space and that renders and generates content; and
an information processing device that includes a monitoring section and a launching section, the monitoring section being configured to detect a trigger on the basis of a snapshot transmitted from the first virtual space, the launching section being configured to launch an instance for operating the second virtual space in a case where the monitoring section detects the trigger.

### Reference Signs List

10: Content delivery system
100: First virtual space
200: Second virtual space
300: Information processing device
301: Monitoring section
302: Launching section
304: Perspective selection section
400: Client

1. An information processing device comprising:
a monitoring section configured to detect a predefined trigger on a basis of a snapshot from a first virtual space acting as a dedicated server; and
a launching section configured to launch, in a case where the monitoring section detects the trigger, an instance for operating a second virtual space that acts as a dedicated server different from the first virtual space and that renders and generates content.

2. The information processing device according to claim 1,
wherein the information processing device selects, as a perspective for rendering in the second virtual space, any of multiple perspectives preset in a space constructed by the second virtual space.

3. The information processing device according to claim 2,
wherein the information processing device selects any of the multiple perspectives on a basis of a perspective selection parameter transmitted from the second virtual space.

4. The information processing device according to claim 2,
wherein the second virtual space renders and generates video content by using, as a rendering perspective, a perspective selected from among the multiple perspectives.

5. The information processing device according to claim 1,
wherein the second virtual space generates content of high quality compared to content generated on a basis of information from the first virtual space.

6. The information processing device according to claim 5,
wherein the content of high quality includes video content of high resolution.

7. The information processing device according to claim 5,
wherein the content of high quality includes video content of high frame rate.

8. The information processing device according to claim 5,
wherein the content of high quality includes content to which information acquired by a sensor is added.

9. The information processing device according to claim 1,
wherein, in a case where the number of sessions between the first virtual space and a client to which the content is provided is equal to or more than a predetermined number, the information processing device scales out resources for constructing the second virtual space.

10. The information processing device according to claim 1,
wherein the content generated by the second virtual space includes video content that is rendered from a different person's perspective other than that for content generated on a basis of information from the first virtual space.

11. The information processing device according to claim 10,
wherein, in a case where the content generated on the basis of the information from the first virtual space includes content viewed from a first-person perspective, the content generated by the second virtual space includes video content viewed from a third-person perspective.

12. The information processing device according to claim 1,
wherein the content generated by the second virtual space is delivered through a CDN (Content Delivery Network).

13. The information processing device according to claim 1,
wherein, in a case where the content generated by the second virtual space includes static content, the information processing device sets a region closest to the first virtual space as a delivery destination for the content.

14. The information processing device according to claim 1,
wherein the first virtual space acts as a dedicated game server.

15. The information processing device according to claim 1,
wherein the second virtual space acts as a dedicated game server that further has rendering and streaming capabilities.

16. An information processing method comprising:
detecting a predefined trigger on a basis of a snapshot from a first virtual space acting as a dedicated server; and
launching, in a case where the trigger is detected, an instance for operating a second virtual space that acts as a dedicated server different from the first virtual space and that renders and generates content.

17. A program for causing a computer to execute an information processing method including
detecting a predefined trigger on a basis of a snapshot from a first virtual space acting as a dedicated server; and
launching, in a case where the trigger is detected, an instance for operating a second virtual space that acts as a dedicated server different from the first virtual space and that renders and generates content.

18. A content delivery system comprising:
a first virtual space that acts as a dedicated server;
a second virtual space that acts as a dedicated server different from the first virtual space and that renders and generates content; and
an information processing device that includes a monitoring section and a launching section, the monitoring section being configured to detect a trigger on a basis of a snapshot transmitted from the first virtual space, the launching section being configured to launch an instance for operating the second virtual space in a case where the monitoring section detects the trigger.
